(19) United States
(12) Patent Application Publication
(10) Pub. No.: US 2014/0146796 A1
(43) Pub. Date: May 29, 2014

(54) BUFFER SIZE REPORTING IN TIME DIVISION HIGH SPEED UPLINK PACKET ACCESS (TD-HSUPA) SYSTEMS

(71) Applicant: QUALCOMM INCORPORATED, San Diego, CA (US)

(72) Inventors: Ming Yang, San Diego, CA (US); Tom Chin, San Diego, CA (US); Qingxin Chen, Del Mar, CA (US); Guangming Shi, San Diego, CA (US)

(73) Assignee: QUALCOMM Incorporated, San Diego, CA (US)

(21) Appl. No.: 13/686,701

(22) Filed: Nov. 27, 2012

(51) Int. Cl. H04W 72/12

(52) U.S. Cl. CPC H04W 72/12
USPC 370/336

(57) ABSTRACT

A method of wireless communication reports buffer size in TD-HSUPA networks. A protocol data unit is transmitted and an artificial buffer size is reported in response to the transmitted PDU. The artificial buffer size corresponds to the size of a scheduling request. The actual buffer size is reported when a NACK is received or when a round trip timer expires. The actual buffer size corresponds to a PDU retransmit size.

### BACKGROUND

1. Field

Aspects of the present disclosure relate generally to wireless communication systems, and more particularly, to efficient reporting of buffer size in a TD-HSUPA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes transmitting a protocol data unit (PDU) and reporting an artificial buffer size in response to transmitting the PDU. The artificial buffer size corresponds to the size of a scheduling request. An actual buffer size is reported when a negative acknowledgment (NACK) is received or when a round trip timer expires. The buffer size corresponds to a PDU retransmit size.

Another aspect discloses an apparatus including means for transmitting a protocol data unit (PDU). Also included is a means for reporting an artificial buffer size in response to transmitting the PDU, where the artificial buffer size corresponds to the size of a scheduling request. Also included is a means for reporting an actual buffer size when a negative acknowledgment (NACK) is received or when a round trip timer expires. The actual buffer size corresponds to a PDU retransmit size.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of transmitting a protocol data unit (PDU) and reporting an artificial buffer size in response to transmitting the PDU. The actual buffer size corresponds to a size of a scheduling request. The program code also causes the processor(s) to report an actual buffer size when a negative acknowledgment (NACK) is received or when a round trip timer expires. The actual buffer size corresponds to a PDU retransmit size.

Another aspect discloses wireless communication having a memory and at least one processor coupled to the memory. The processor(s) is configured to transmit a protocol data unit (PDU) and to report an artificial buffer size in response to transmitting the PDU. The artificial buffer size corresponds to the size of a scheduling request. The processor(s) is also configured to report an actual buffer size when a negative acknowledgment (NACK) is received or when a round trip timer expires. The actual buffer size corresponds to a PDU retransmit size.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a block diagram illustrating a method for reporting buffer size according to one aspect of the present disclosure.

FIG. 5 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

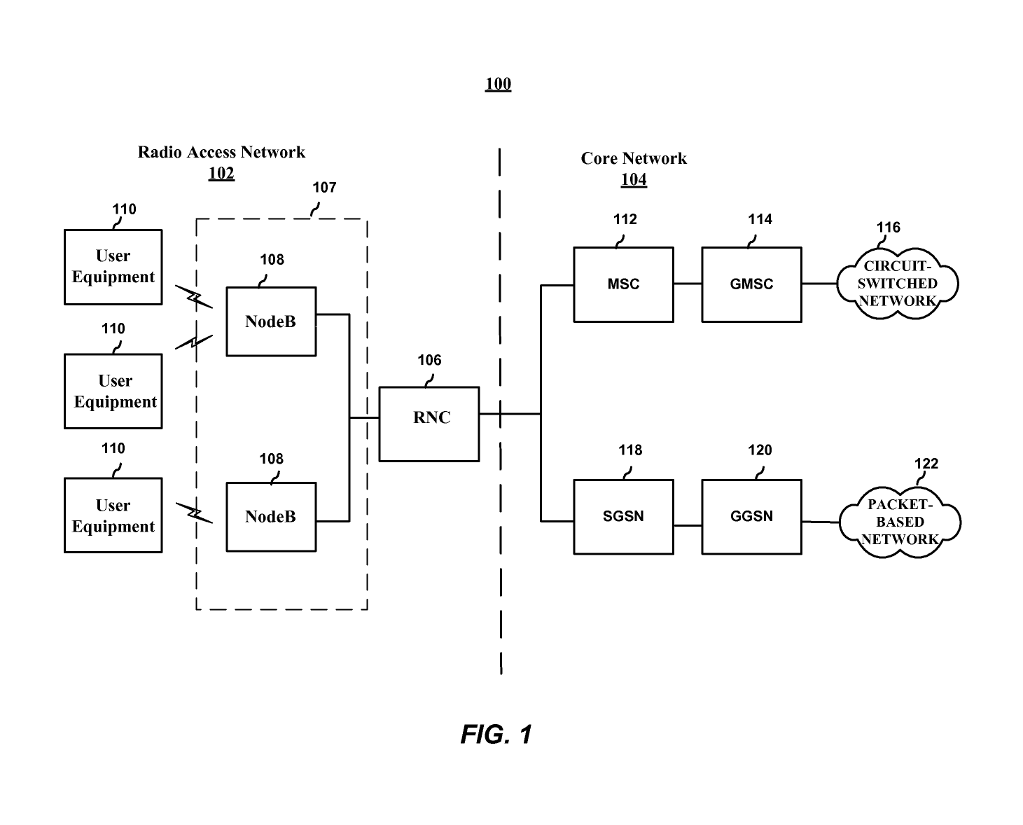

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

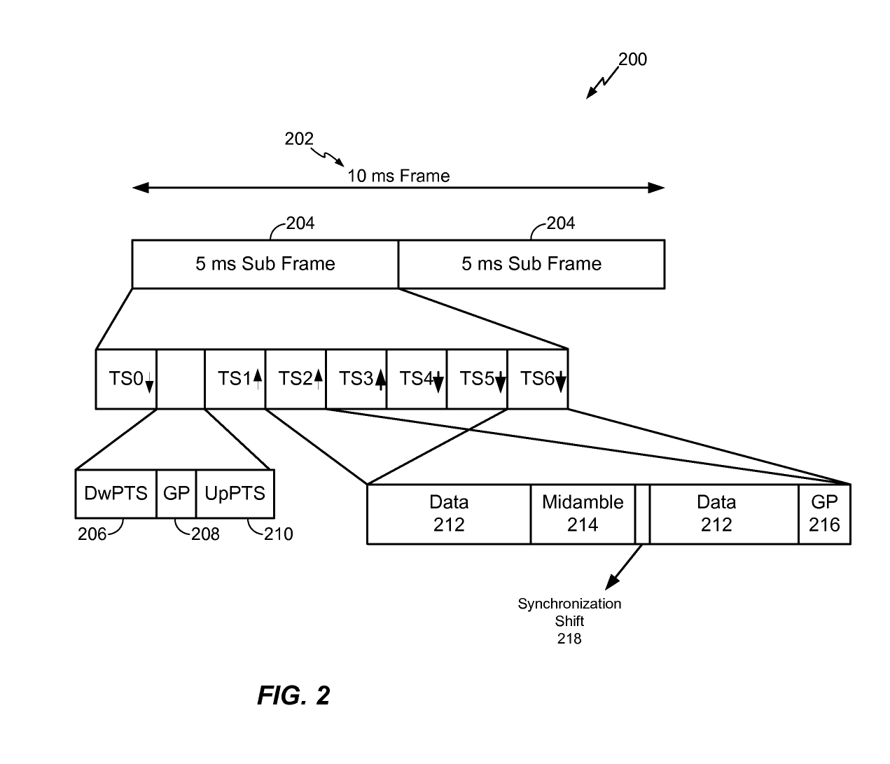

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

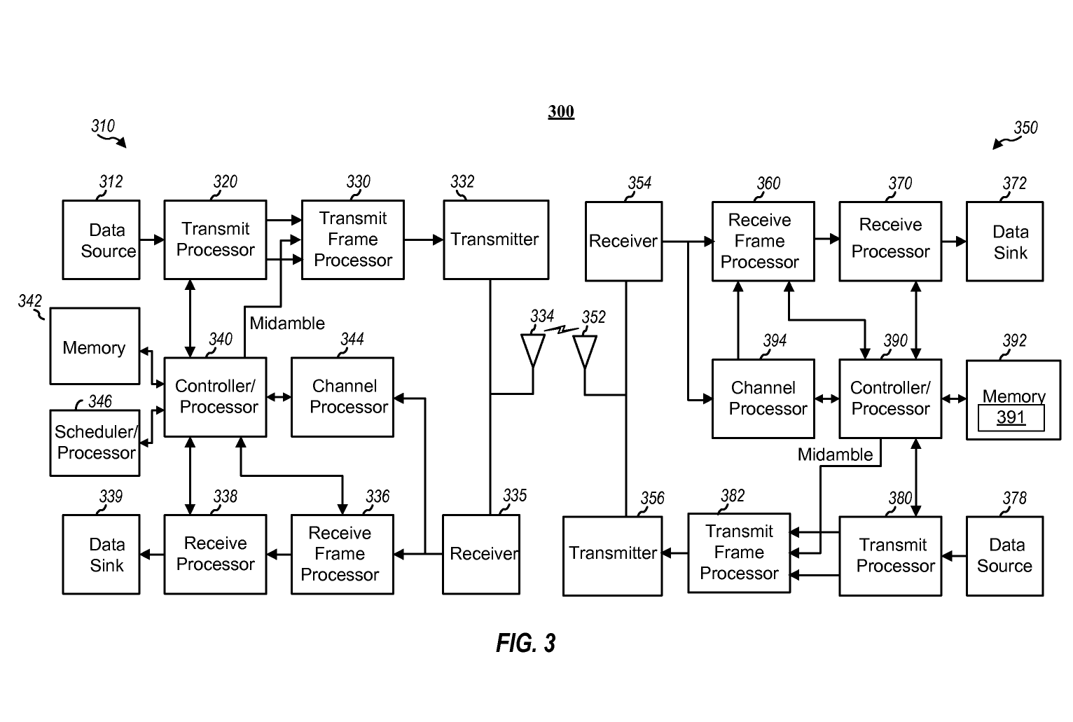

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store an artificial buffer size module 391 which, when executed by the controller/processor 390, configures the UE 350 for inter-RAT/inter-frequency measurements. A scheduler/processor 346 at the node B 310 may be used to allocate resources to the UEs and schedule downlink and/or uplink transmissions for the UEs.

High speed uplink packet access (HSUPA) is an enhancement to TD-SCDMA, and enhances uplink throughput. HSUPA introduces the following physical channels: enhanced uplink dedicated channel (E-DCH), E-DCH physical uplink channel (E-PUCH), E-DCH uplink control channel (E-UCCH), and E-DCH random access uplink control channel (E-RUCCH).

The E-DCH is a dedicated transport channel and may be utilized to enhance an existing dedicated channel (DCH) transport channel carrying data traffic. The E-PUCH carries E-DCH traffic and scheduling information (SI). The e-PUCH can be transmitted in burst fashion. The E-UCCH carries Layer 1 information for E-DCH. The E-RUCCH includes the uplink physical control channel and carries scheduling information (SI), including a scheduling request and the UE ID (i.e., enhanced radio network temporary identifier (E-RNTI).)

Uplink communications pursuant to HSUPA occur as follows. First, a UE sends a resource request (for example, scheduling information (SI)), to the node B via E-PUCH or E-RUCCH seeking permission from the node B to transmit on the uplink. Next, the node B, which controls the uplink radio resources, allocates resources to the UE in the form of scheduling grants (SG) to individual UEs based on their requests. Next, the UE transmits on the uplink after receiving grants from the node B. The UE determines the transmission rate and corresponding transport format combination (TFC) based on the received grants. The UE may request additional grants if it has more data to transmit. Hybrid automatic repeat request (HARQ) procedures may be employed for rapid retransmission of improperly received data packets between the UE and node B.

A scheduling request, including scheduling information, may be sent by a UE to a node B when the UE desires to send data to the node B. The scheduling information (SI) includes information to coordinate scheduling of the UE data transmission to a node B. In certain situations, a UE may transmit scheduling information to the node B. For example, a UE may transmit scheduling information when the UE has data to send but no grant, when the UE has a grant but higher priority data arrives for which the UE desires a new grant, when the UE performs handover to a different cell or different frequency and has data to send, when a timer, T-SI or T-SI-NST, expires, or when the MAC-e PDU (medium access control protocol data unit) has sufficient room for the scheduling information to be included. The timer, T-SI, is a timer for periodic triggering of the scheduling information (SI) transmission. The timer for periodic triggering of SI for non-scheduled transmission, may be referred to as T-SI-NST. A non-scheduled transmission (NST) occurs when the radio network controller (RNC) assigns a static grant. Grants for non-scheduled transmissions are given in terms of timeslots, codes, and maximum power via radio resource control (RRC) signaling.

The scheduling information (SI) transmission may occur in two ways. First, in-band scheduling information transmissions may be included in the MAC-e PDU on the E-PUCH. The scheduling information may be sent alone or with a data packet. Second, out-of-band scheduling information transmissions may be included on the E-RUCCH. In-band transmissions are quick. Out-of-band transmissions are slower, and could be even slower if a resource collision with another UE occurs during the random access procedure.

The scheduling information may include different information used for scheduling, such as the highest priority logical channel ID (HLID), the total E-DCH buffer size (TEBS), the highest priority logical channel buffer status (HLBS), the UE power headroom (UPH) and the path loss information. The highest priority logical channel identifier (HLID) field identifies the highest priority logical channel with available data. If multiple logical channels exist with the highest priority, the one corresponding to the highest buffer occupancy may be reported.

The total E-DCH buffer size (TEBS) field identifies the total amount of data available across all logical channels for which reporting has been requested by the radio resource controller (RRC) and indicates the amount of data (in number of bytes) available for transmission and retransmission in the radio link control (RLC) layer. When the medium access control is connected to an acknowledged mode (AM) RLC entity, the TEBS field may also include the control protocol data units (PDUs) to be transmitted and RLC PDUs outside the RLC transmission window. The RLC PDUs that have been transmitted but not negatively acknowledged by the NodeB are not included in the TEBS. The actual value of the TEBS field transmitted is one of 31 values that are mapped to a range of number of bytes. The TEBS corresponds to an index table defined by the specification. For example, an index value of 5 corresponds to a buffer size in the range of 24 to 32 bytes, (e.g., 5 mapping to 24<TEBS<32).

The highest priority logical channel buffer status (HLBS) field indicates the amount of data available from the logical channel identified by the HLID, relative to the highest value of the buffer size range reported by TEBS when the reported TEBS index is not 31, and relative to 50000 bytes when the reported TEBS index is 31. The value taken by HLBS is one of 16 values that map to a range of percentage values. For example, an index value of 2 corresponds to a HLBS of total buffer size in the range of 6%-8%, (e.g., 2 maps to 6%<HLBS<8%).

The UE power headroom (UPH) field indicates the ratio of the maximum UE transmission power and the corresponding downlink physical control channel (DPCCH) code power. The path loss information reports the path loss ratio between the serving cells and neighboring cells.

The buffer size calculation is now described. As noted above, the RLC PDUs that have been transmitted but not negatively acknowledged by the NodeB are not included in the buffer size calculation (i.e., TEBS). Because a UE does not know whether an ACK or a NACK will be received when sending a PDU, the UE does not know whether a retransmission will be requested. Thus, because the UE does not assume a retransmission will be requested, the buffer size calculation (i.e., TEBS) does not account for a potential retransmission. The buffer size is updated to reflect the requested retransmission only when a NACK is actually received.

The quantization into supported transport block sizes or the triggering of the scheduling information impacts the data transmission. When the size of the data plus header is less than or equal to the transport block (TB) size of the E-TFC selected by the UE minus 29 bits, then a data description indicator (DDI) value [111111] is appended at the end of the MAC-e header and the scheduling information is concatenated into the MAC-e PDU. The DDI value [111111] indicates the scheduling information is concatenated in the MAC-e PDU.

Otherwise, if the size of the data plus header is less than or equal to the transport block size of the E-TFC selected by the UE minus 23 bits, the scheduling information is concatenated into the MAC-e PDU. In any other case, it is understood that another MAC-e PDU or scheduling information does not fit and an additional DDI field is not reserved in the transport block.

When the UE reports a TEBS value of zero, which indicates a buffer size of zero bits, to the NodeB, the NodeB stops scheduling the UE. For the UE to re-transmit a PDU due to a NACK, or for the UE to transmit an RLC status PDU, the UE performs an E-RUCCH process to send a schedule request, which is a slow process. The, RLC status PDU is when the receiver (RX) side informs the transmitter (TX) side which PDUs are received, and which PDUs are not received. When the UE performs the E-RUCCLH process, latency is increased and throughput is degraded because the UE waits for a scheduling grant before the UE can send the retransmission. An RLC retransmission occurs when the time waiting to receive the grant is longer than an RLC polling timer and/or status prohibit timers. RLC retransmissions waste air interface capacity.

In one aspect of the present disclosure, when the UE has transmitted a PDU but not yet received an ACK or a NACK (i.e., an ACK/NACK PDU is pending), the UE initiates a timer, such as the round trip delay timer, RTT. The round trip refers to the time from when a PDU is sent to a NodeB plus the time waiting for a response from the NodeB. Similarly, when a status PDU has been transmitted, the UE initiates the round trip delay timer.

After starting the timer, the UE does not report the actual buffer size, which is 0 after transmitting the PDU (i.e., TEBS=0). Instead, if the round trip delay timer has not expired, the UE reports an artificial buffer size that is large enough to trigger a scheduling grant. In one example, the UE reports a buffer size corresponding to TEBS=23, which is the minimum size to initiate a scheduling grant for sufficient resources to transmit a scheduling request. The artificial buffer size is repeatedly reported until the round trip timer expires. The artificial buffer size will trigger a scheduling grant, permitting the UE to quickly send the retransmission, if triggered to do so either by a NACK, or by not receiving any response from the NodeB.

Once the UE receives an ACK, the UE reports the actual buffer size (e.g., TEBS=0). Similarly, if the UE receives a NACK or the timer expires, the UE reports the actual buffer size, which includes a size of the PDU to be re-transmitted. It is noted that when the timer expires and no response from the NodeB has been received, the UE treats the lack of response as a NACK and re-transmits the PDU.

Utilizing an artificial buffer size can avoid the situation when the UE has data but the NodeB has stopped scheduling grants. That is, by sending an artificial buffer size, the UE will receive a scheduling grant and can thus immediately send a scheduling request to enable retransmission of any PDUs that were not properly received. Additionally, the artificial buffer size reporting is useful when the UE performs E-PUCH (in-band) procedures for a scheduling request, which may result in degraded throughput and user perception. In particular, when a UE makes a schedule request through the E-RUCCH procedure, it takes longer time to receive a grant for retransmission, thus degrading throughput.

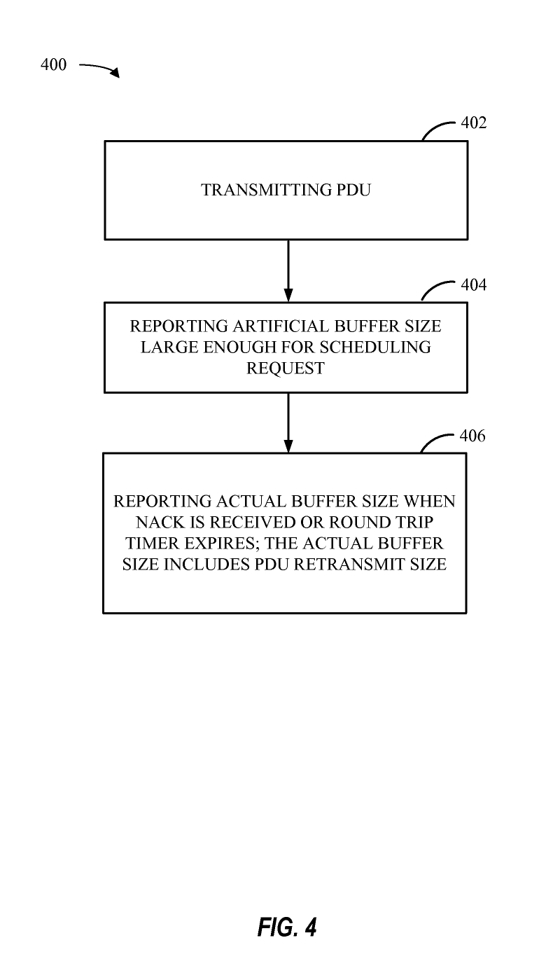

FIG. 4 shows a wireless communication method 400 according to one aspect of the disclosure. Initially, a UE 350 transmits a PDU, as shown in block 402. The UE 350 also reports an artificial buffer size that is sufficiently large to trigger a scheduling grant for enough resources to transmit a scheduling request, as shown in block 404. At block 406, the actual buffer size is eventually reported. The actual buffer size is reported when a NACK is received, an ACK is received or when a round trip timer expires. When a NACK or nothing is received, the actual buffer size corresponds to the size of the PDU to be retransmitted.

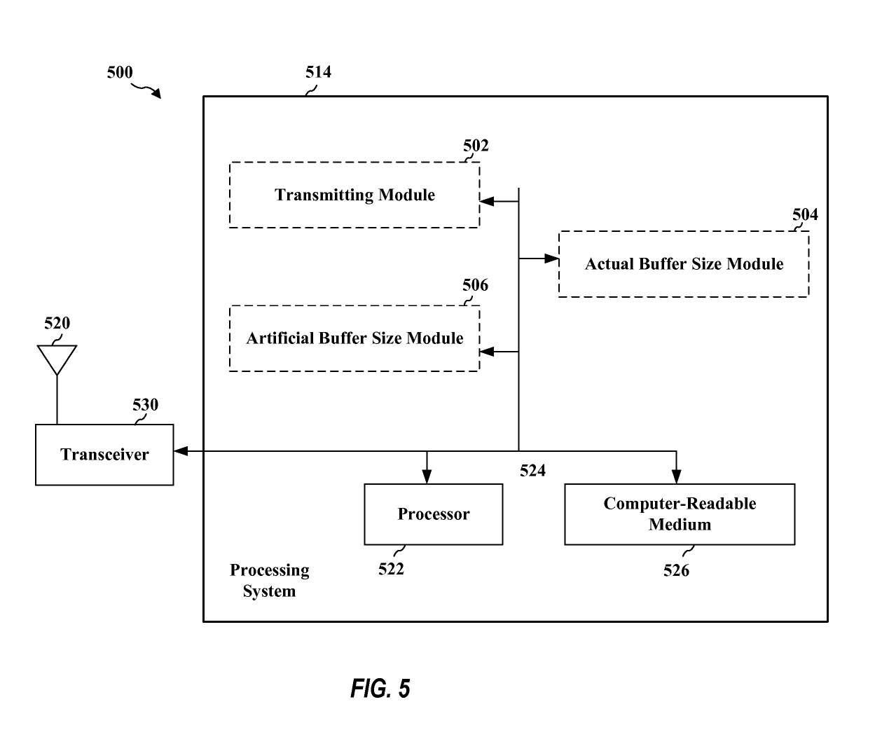

FIG. 5 is a diagram illustrating an example of a hardware implementation for an apparatus 500 employing a buffer reporting system 514. The buffer reporting system 514 may be implemented with a bus architecture, represented generally by the bus 524. The bus 524 may include any number of interconnecting buses and bridges depending on the specific application of the buffer reporting system 514 and the overall design constraints. The bus 524 links together various circuits including one or more processors and/or hardware modules, represented by the processor 522 the modules 502, 504, 506 and the computer-readable medium 526. The bus 524 may also link various other circuits such as timing sources, peripherals, voltage regulators, and power management circuits, which are well known in the art, and therefore, will not be described any further.

The apparatus includes a buffer reporting system 514 coupled to a transceiver 530. The transceiver 530 is coupled to one or more antennas 520. The transceiver 530 enables communicating with various other apparatus over a transmission medium. The buffer reporting system 514 includes a processor 522 coupled to a computer-readable medium 526. The processor 522 is responsible for general processing, including the execution of software stored on the computer-readable medium 526. The software, when executed by the processor 522, causes the buffer reporting system 514 to perform the various functions described for any particular apparatus. The computer-readable medium 526 may also be used for storing data that is manipulated by the processor 522 when executing software.

The buffer reporting system 514 includes a transmitting module 502 for transmitting a protocol data unit (PDU) to a node B. The buffer reporting system 514 includes an artificial buffer size module 504 for reporting an artificial buffer size having a size large enough to include a scheduling request. The buffer reporting system 514 also includes an actual buffer size module 506 for reporting an actual buffer size, different from the reported artificial buffer size. The modules may be software modules running in the processor 522, resident/stored in the computer-readable medium 526, one or more hardware modules coupled to the processor 522, or some combination thereof. The buffer reporting system 514 may be a component of the UE 350 and may include the memory 392, and/or the controller/processor 390.

In one configuration, an apparatus such as a UE is configured for wireless communication including means for transmitting and means for reporting. In one aspect, the above means may be the antennas 352, the controller/processor 390, the transmit processor 380, the transmit frame processor 382, the memory 392, the buffer reporting module 391, transmitting module 502, artificial buffer size module 504, actual buffer size module 506 and/or the an buffer reporting system 514 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
transmitting a protocol data unit (PDU);
reporting an artificial buffer size corresponding to a size of a scheduling request, in response to transmitting the PDU; and
reporting an actual buffer size when a negative acknowledgment (NACK) is received or a round trip timer expires, the actual buffer size corresponding to a PDU retransmit size.

2. The method of claim 1, further comprising initiating the round trip timer before transmitting the PDU.

3. The method of claim 1, in which the reporting the artificial buffer size occurs repeatedly for a duration of the round trip timer.

4. The method of claim 1, further comprising reporting the actual buffer size after an acknowledgement (ACK) is received.

5. The method of claim 4, in which the actual buffer size is zero.

6. An apparatus for wireless communication, comprising:
means for transmitting a protocol data unit (PDU);
means for reporting an artificial buffer size corresponding to a size of a scheduling request, in response to transmitting the PDU; and
means for reporting an actual buffer size when a negative acknowledgment (NACK) is received or a round trip timer expires, the actual buffer size corresponding to a PDU retransmit size.

7. The apparatus of claim 6, further comprising means for initiating the round trip timer before transmitting the PDU.

8. The apparatus of claim 6, in which the means for reporting the artificial buffer size occurs repeatedly for a duration of the round trip timer.

9. The apparatus of claim 6, further comprising means for reporting the actual buffer size after an acknowledgement (ACK) is received.

10. The apparatus of claim 9, in which the actual buffer size is zero.

11. A computer program product for wireless communication in a wireless network, comprising:
a non-transitory computer-readable medium having non-transitory program code recorded thereon, the program code comprising:
program code to transmit a protocol data unit (PDU);
program code to report an artificial buffer size corresponding to a size of a scheduling request, in response to transmitting the PDU; and
program code to report an actual buffer size when a negative acknowledgment (NACK) is received or a round trip timer expires, the actual buffer size corresponding to a PDU retransmit size.

12. The computer program product of claim 11, further comprising program code to initiate the round trip timer before transmitting the PDU.

13. The computer program product of claim 11, in which the program code to report the artificial buffer size reports repeatedly for a duration of the round trip timer.

14. The computer program product of claim 11, further comprising program code to report the actual buffer size after an acknowledgement (ACK) is received.

15. The computer program product of claim 14, in which the actual buffer size is zero.

16. An apparatus for wireless communication, comprising:
a memory; and
at least one processor coupled to the memory, the at least one processor being configured:
to transmit a protocol data unit (PDU);
to report an artificial buffer size corresponding to a size of a scheduling request, in response to transmitting the PDU; and
to report an actual buffer size when a negative acknowledgment (NACK) is received or a round trip timer expires, the actual buffer size corresponding to a PDU retransmit size.

17. The apparatus of claim 16, in which the at least one processor is further configured to initialize the round trip timer before transmitting the PDU.

18. The apparatus of claim 16, in which at least one processor configured to report the artificial buffer size is further configured to repeatedly report for a duration of the round trip timer.

19. The apparatus of claim 16, in which the at least one processor is further configured to report the actual buffer size after an acknowledgement (ACK) is received.

20. The apparatus of claim 19, in which the actual buffer size is zero.
